(19) United States
(12) Patent Application Publication
(10) Pub. No.: US 2026/0066145 A1
(43) Pub. Date: Mar. 5, 2026

(54) RADIATION SHIELDING MATERIAL, PROCESS FOR MANUFACTURE AND APPARATUS

(71) Applicant: Gatan, Inc., Pleasanton, CA (US)

(72) Inventors: Douglas Whitfield NORTON, Fairborn, OH (US); Colin Geoffrey TREVOR, Pleasanton, CA (US); Edward Michael JAMES, San Francisco, CA (US)

(73) Assignee: Gatan, Inc., Pleasanton, CA (US)

(21) Appl. No.: 19/308,515

(22) Filed: Aug. 25, 2025

Related U.S. Application Data
(60) Provisional application No. 63/688,329, filed on Aug. 29, 2024.

(51) Int. Cl. G21F 1/08; C22C 1/02; C22C 28/00

(52) U.S. Cl. CPC G21F 1/085; C22C 1/02; C22C 28/00

(57) ABSTRACT

An alloy consisting of bismuth, tin and antimony is described. In embodiments, the alloy may comprise substantially Sn=3.4-9.8 at % (2.0 %-6.0 % by weight), Sb=4.3-4.8 at % (2.6 %-2.9 % by weight), and Bi=85.6-92.4 at % (91.2 %-95.5 % by weight). Indium may replace the tin component. The alloy may be used as a radiation shield. A process for preparing and forming the alloy is described.

### CROSS REFERENCE TO RELATED APPLICATION

This application claims priority to and incorporates by reference in its entirety U.S. provisional patent application No. 63/688,329, filed on Aug. 29, 2024 and titled RADIATION SHIELDING MATERIAL, PROCESS FOR MANUFACTURE AND APPARATUS.

### BACKGROUND

Following the discovery of radioactivity and subsequent x- and gamma radiations, the first international body for radiation protection, now known as ICRP published shielding and protection guidelines in the early 20th century (1950s) as it was well known by this time that ionizing radiation causes harm. By this time, shielding calculations and experimentation revealed that materials with high atomic number (Z), and high density, attenuate photon based ionizing radiations with efficiency over their low Z, low density counterparts.

This realization led to the widespread use of elemental lead and its alloys in radiation shielding applications, and subsequent environmental damage, contamination, and deleterious impacts to human health. Current methods of lead alloying can result in water, soil, and air pollution, particularly in occupational exposures. Lead poisoning often manifests in early childhood resulting in neurological deficit, namely, brain and central nervous system damage often causing death. Those who do survive lead poisoning often suffer from reduced intelligence quotient and multi-system body system injury, even at concentrations considered not to result in lethality. Thus, an alternative to lead for radiation shielding is highly desirable.

### DETAILED DESCRIPTION

Embodiments of alloys having radiation shielding properties are described herein. Novel alloys of bismuth, tin, and antimony are described as well as processes for manufacture and apparatuses using the novel alloys as radiation shields. In contrast to lead, bismuth is known to have very low bioavailability and is currently in use with pharmaceuticals, including antacids.

Of the heavy elements, alloys of bismuth provide a significantly safer alternative to lead-alloys currently employed in radiation shielding. Due to the far lower toxicity of bismuth and its lack of ability to cross through skin, there is far less concern of environmental contamination and human health effects. Thus, in embodiments, the alloys described may be used as a full lead replacement in sources of ionizing radiation where energy is at or below 500 keV.

The alloys described herein are machinable with improved mechanical stability compared to conventional lead-based compounds and pure bismuth compounds. Bismuth has been previously proposed as a shielding material but has not been used because in its pure form it is too brittle for application in the form of a machined part, and too fragile to be used as a structural component in many applications. The alloys described herein are both not brittle and machinable without losing the X-ray absorption properties required for protection. In embodiments, the alloys described are approximately 98% equivalent in their ability to attenuate photon-based radiations, as compared to lead, up to approximately 500 keV, thus making them suitable for larger scale applications in electron microscopy and related components where protection from stray radiations is required. The alloys' very close attenuation characteristic to lead and their machinability makes these alloys a potential direct replacement for lead parts without significant re-design, and for use in compact geometries where impregnating with bismuth doesn't provide enough attenuation per unit volume of absorbing material.

Due to the far lower toxicity of bismuth and its lack of ability to cross through skin, there is far less concern of environmental contamination and human health effects. Thus, as proposed, there is practical use for this invention as a full lead replacement in other machine sources of ionizing radiations where energy is at or below 500 keV.

In embodiments a radiation shield material in the form of a metal alloy of bismuth, contains no lead, and contains tin and antimony. In preferred embodiments the following component percentages may be used to form alloys for radiation shielding. All percentages are expressed as an atomic fraction unless otherwise noted. Trace amounts of other elements may be present and still be consistent with the invention.
Sn=3.4-9.8 at % (2.0%-6.0% by weight)
Sb=4.3-4.8 at % (2.6%-2.9% by weight)
Bi=85.6-92.4 at % (91.2%-95.5% by weight)

In a further preferred embodiment an alloy for radiation shielding comprises:
Sn=9.8 at % (6.0% by weight)
Sb=4.6 at % (2.9% by weight)
Bi=85.6 at % (91.2% by weight)

An advantage of the alloys described herein is that they do not “gum” up drill bits and other CNC based tools like lead and its alloys do because the material is approximately two times the hardness of current lead shielding materials.

Bismuth and antimony both form rhombohedral crystals as they cool with tin producing a tetragonal crystal. Under controlled conditions, these crystals expand slightly forcing atmospheric air out of the material with visible cross linking in the structure. This effect results in a material without significant voids. In embodiments, the absence of voids is important where the material will be present in a vacuum environment.

The alloys described are self-supporting and rigid. Another advantage of the alloys described is that their melting point is low and it can therefore be easily cast using various mold materials. They are also electrically conductive. Shielding capability of the described alloys for for x-rays up to 500 keV photon energy is greater than 95% that of pure lead. The overall effective attenuation for photon based radiation is nearly identical to lead with an approximate difference in same volume of 0.18 plus or minus 0.15 percent.

The average density of the new alloy is 9.55 g/cc compared to lead with an average density of 11.34 g/cc. The resulting alloy is thus, 17.1% physically less massive which reduces fuel use, and by extension, carbon emissions.

In an exemplary process, bismuth-antimony stock, 95% Bi and 5% Sb by weight are combined with tin in a crucible, 3% by weight with boric acid to remove impurities and oxidized material. In embodiments, Teton Petrobond 130 industrial metal casting sand is compressed into a form around a 3D printed mold. The material is then heated to 600 degrees F. in a furnace, removed from the furnace and allowed to cool inside the crucible for 5 minutes. The resulting “slag” is then removed from the top by scraping with a stainless steel blade. It is then poured into the casting mold created by the sand. The material is allowed to naturally cool in ambient conditions for 30 minutes prior to being quenched with water to stop excessive crystal formation. The quenching process is critical to ensure mechanical stability, and structural integrity of the alloy. Without these steps, the material ends up becoming excessively brittle as there is no lattice formation with the Bi—Sb and Tin crystals.

In embodiments, Sn may be replaced with Indium (In) in the same portions as noted for Sn.

In embodiments the novel compounds described herein may be used for shielding of a radiation source in confined spaces/volumes where the machined material is part of the structural design. In embodiments the compounds may be used for (without limitation) protection of users of electron microscopes, X-ray diffractometers and for protection of users and unintentional dose of patients in medical equipment including X-ray cameras and Computed Tomography (CT) machines. Further embodiments may include shielding for human radioprotection in the medical space. Such embodiments may include latex impregnated with bismuth alloys described herein.

It will be understood that, although the terms first, second, third, etc. may be used herein to describe various elements, these elements should not be limited by these terms. These terms may be used to distinguish one element from another. For example, a first element may be termed a second element and a second element may be termed a first element without departing from the scope of the present invention. As used herein, the term “and/or” may include any and all combinations of one or more of the associated listed items.

It will be understood that when an element such as a layer, region, or substrate is referred to as being “on” or extending “onto” another element, it may be directly on or extend directly onto the other element or intervening elements may also be present. In contrast, when an element is referred to as being “directly on” or extending “directly onto” another element, there may be no intervening elements present. It will also be understood that when an element is referred to as being “connected” or “coupled” to another element, it may be directly connected or coupled to the other element and/or connected or coupled to the other element via one or more intervening elements. In contrast, when an element is referred to as being “directly connected” or “directly coupled” to another element, there are no intervening elements present between the element and the other element. It will be understood that these terms are intended to encompass different orientations of the element in addition to any orientation depicted in the figures.

Relative terms such as “below,” “above,” “upper,”, “lower,” “horizontal” or “vertical” may be used herein to describe a relationship of one element, layer, or region to another element, layer, or region as illustrated in the figures. It will be understood that these terms are intended to encompass different orientations of the device in addition to the orientation depicted in the figures.

Having described the embodiments in detail, those skilled in the art will appreciate that, given the present description, modifications may be made to the embodiments described herein without departing from the spirit of the inventive concept. Therefore, it is not intended that the scope of the invention be limited to the specific embodiments illustrated and described.

We claim:

1. An alloy comprising:
Sn or In=3.4-9.8 at % (2.0%-6.0% by weight),
Sb=4.3-4.8 at % (2.6%-2.9% by weight), and
Bi=85.6-92.4 at % (91.2%-95.5% by weight).

2. An alloy comprising:
Sn or In=9.8 at % (6.0% by weight),
Sb=4.6 at % (2.9% by weight), and
Bi=85.6 at % (91.2% by weight).

3. A process for preparing an alloy, comprising:
combining in a crucible bismuth-antimony stock of 95% Bi and 5% Sb by weight with 3% by weight of Sn or In, and boric acid;
heating the bismuth-antimony stock, the tin and the boric acid to a predetermined temperature to form a heated alloy;
removing slag from the heated alloy;
casting the heated alloy in a mold;
cooling the mold in air for a predetermined period of time;
removing the casting and quenching it.

4. A radiation shield comprising the alloy of claim 1.

5. The radiation shield of claim 4 configured to shield photon-based radiation up to 500 keV.

6. A radiation shield comprising the alloy of claim 2.

7. The radiation shield of claim 6 configured to shield photon-based radiation up to 500 keV.

8. A radiation shield prepared by the process of claim 3.

9. The radiation shield of claim 8 configured to shield photon-based radiation up to 500 keV.

10. The process of claim 3, wherein the predetermined time is substantially 30 minutes.

11. The process of claim 3, wherein the predetermined temperature is 600 degrees F.
